(19) United States
(12) Patent Application Publication
(10) Pub. No.: US 2008/0022866 A1
(43) Pub. Date: Jan. 31, 2008

(54) SHEET PUNCHING AND EMBOSSING MACHINE WITH REGISTER ORIENTING AND METHOD FOR OPERATING A SHEET PUNCHING AND EMBOSSING MACHINE

(75) Inventors: Hendrik FRANK, Heidelberg (DE); Stefan GORTZ, Monchengladbach (DE); Miroslav VANEK, Monchengladbach (DE)

Correspondence Address: HEIDELBERGER DRUCKSMASCHINEN AKTIENGESELISCHAFT;C/O KEATING & BENNETT, LLP, 8180 GREENSBORO DRIVE, SUITE 850, MCLEAN, VA, 22102, US

(73) Assignee: HEIDELBERGER DRUCKMASCHINEN AG, Heidelberg (DE)

(21) Appl. No.: 11/779,501

(22) Filed: Jul. 18, 2007

(30) Foreign Application Priority Data
Jul. 26, 2006 (DE) 10 2006 034 509.6
Jul. 26, 2006 (DE) 10 2006 034 511.8
Apr. 30, 2007 (DE) 10 2007 020 497.5

(51) Int. Cl. B31F 1/07

(52) U.S. Cl. 101/4; 101/18

(57) ABSTRACT

A sheet punching and embossing machine includes a sheet feeder unit, a punching station, at least one additional processing station, a machine control system and a sheet transport system which has circulating gripper carts. Grippers are fastened on the gripper carts by which the sheets can be grabbed at a gripper margin and moved through the machine. The circulating gripper carts are driven at their outer ends by at least one linear drive each and the sheets at their sheet stopping positions in the punching station and the processing stations are register-oriented by the incremental movement generated by the linear drives.

### BACKGROUND OF THE INVENTION

1. Field of the Invention

The present invention relates to a sheet punching and embossing machine with register orienting and a method for operating such a sheet punching and embossing machine.

2. Description of the Related Art

Punching refers to a cutting with closed, geometrical forms, which can be circular, oval, or polygonal, as well as special shapes of every kind. Practices in the post-processing of a print job, such as punching with a hollow punch, rounding corners, and register punching are also included in this field. The punching is done against a base or against a punch, and sometimes there are also shearing processes (cf. Post-processing, Training Manual for Bookbinders, Bundesverband Druck e.V. 1996, page 351 et seq.) are involved. Packaging materials of paper, cardboard, paperboard or corrugated cardboard are primarily punched in sheet format. During the punching process, however, groove lines or blind imprints may also be introduced into the finished sheets. This complex process makes it essential to punch the sheets individually. Since the end products are packages with demanding technical and graphical requirements (such as those for cosmetics, cigarettes, medicines, foods, etc.), special requirements are placed not only on the packaging materials themselves, but also one needs punching dies with minimal tolerances and extremely precise and reliable punching machines for optimal results. These demands are best met by flat bed punches. The printed sheets, stacked on a pallet, are fed to the punch. In the machine, the sheets being punched are first oriented accurately in an orienting mechanism, picked up by a gripping cart and positioned exactly in the punching mechanism between a fixedly mounted bottom table and a top table, arranged to move vertically via a bent lever or eccentric gearing.

In known sheet punching and embossing machines, used for punching, breakaway, embossing and stacking of sheets of paper, cardboard, and the like, it is known how to move the sheets by means of gripper carts through the individual stations of the machine. On the gripper carts are secured grippers, which grab the sheets by a front end thereof, the gripper carts themselves being moved on endless chains through the machine. Thanks to this kind of movement of the sheets through the machine, a continuous operation is made possible in the individual sequentially arranged stations of the machine.

Such a flat bed punch is known, for example, from DE 30 44 083 A1. The two tables are provided with cutting and grooving dies and corresponding counterplates, with which the finished copies are punched out from the sheets carried between the table surfaces in a timed cycle, and at the same time the grooves needed for making a clean fold are indented. In the subsequent breakaway mechanism, the waste is mechanically removed via breakaway dies. Finally, depending on the machine construction, the punched copies can be separated in a copy separation mechanism provided for this.

To achieve a high product quality for the punched sheets, it is necessary for sheet and dies to be oriented register-true relative to each other. In the punching station of a sheet punching and embossing machine, punching die and punching groove plates must be brought to an exact position in the perimeter direction. Furthermore, one must make sure that both tools are oriented exactly perpendicular to the sheet transport direction without slanting. This reference position is called “first blade.” In the following processing stations, the tools must be adjusted relative to the position of the first blade—for example, the breakaway board in the waste stripper and the copy separation screen in the copy separating station. Here, the tools must each be adjusted in their three degrees of freedom. During the operation of the sheet punching and embossing machine, it may be necessary to readjust the position of the tools in the punching station. The tools in the following processing stations must likewise be readjusted in order to bring them again into the correct position relative to the “first blade.”

This cumbersome setup work of the tools and dies ensures that the sheets are processed register-true. Here, the register describes the positional precision of the printed image relative to the cutting, grooving and breakaway edges of the sheet. A distinction is drawn in this context between perimeter register, i.e., the positional precision in the machine entry direction, and side register, i.e., the positional precision transverse to the machine entry direction.

A drawback to the register-true orienting in the prior art is the fact that the large outfitting time, i.e., the amount of time spent on adjusting the tools and dies, detracts from the machine productivity.

### SUMMARY OF THE INVENTION

In order to overcome the problems described above, preferred embodiments of the present invention provide a sheet punching and embossing machine having short outfitting time and high productivity.

According to a preferred embodiment of the present invention, a sheet punching and embossing machine includes at least one punching station and at least one additional processing station, such as a breakaway station or a copy separating station, a machine control system and a sheet transport system. The sheet transport system preferably includes circulating gripper carts with gripper bridges which are outfitted with grippers in order to grasp sheets of paper, cardboard, and the like by a gripping edge and thereby move the sheets through the machine. The gripper carts are driven at their outer ends by at least one linear drive each. At their sheet stopping positions in the punching station and the additional processing stations, the sheets are register-oriented in their perimeter direction and in their slanting position by the incremental movement generated by the linear drives. The slanting orientation occurs by unequal movement of right and left travel carts of a gripper cart along the guide rails of the sheet transport system, formed by stator segments, i.e., the travel carts are driven for unequal distances. The sideways orienting is done by an additional device arranged to perform the sideways orienting.

In one preferred embodiment of the present invention, the sheet punching and embossing machine preferably includes, at least before the first processing station, an optical measuring system arranged to survey the sheet. Alternatively, the sheet punching and embossing machine can also have an optical measuring system arranged in front of each processing station. The measuring system uses elements familiar to the specialist such as cameras, lasers and sensors to determine the actual position of the sheet.

In one preferred embodiment of the sheet punching and embossing machine, the measuring system, the machine control system and the sheet transport system are preferably linked together by data lines, especially by a feedback control circuit, and data can therefore be exchanged.

In one preferred embodiment, the sheet punching and embossing machine preferably includes a mechanism arranged to determine the position of the gripper cart. This mechanism includes sensors fixed to the machine frame and signal generators fixed to the respective gripper carts. The signals emitted by the signal generators are received by the sensors and in this way, the position of a particular gripper cart is determined. The sensors for this mechanism are preferably provided in the processing stations and the punching station.

In one preferred embodiment of the sheet punching and embossing machine, the gripper carts can move both forward and backward through the use of linear drives, i.e., in the direction of sheet transport, dictated by the direction from feeder unit to delivery unit, and also in the opposite direction. The backward movement can be advantageously used especially for the sheet-orienting, and also when passing off the sheet to the grippers of the gripper cart, thus contributing to a faster and more precise orienting and passing off.

Moreover, another preferred embodiment of the present invention provides a method for operating a sheet punching and embossing machine including a sheet feeder unit, at least one processing station and one sheet transport system. An individual sheet is singled out from the sheet stack by a sheet feeder unit and is transported across a feed table. Here, the sheet is roughly oriented at its front and side edge and then grabbed by a preliminary gripper system. Once the sheet has been grabbed, the print image of the sheet is optically surveyed with a measuring system, which preferably includes cameras and/or sensors. The actual position of the print image is compared with its nominal position. From the comparison of the position values, correction values are calculated for a slanting sheet, a side register and a perimeter register, and these calculations are provided to the machine control system. The register-true sideways orienting of the sheet is done by a feeding system. The sideways oriented sheet is passed off to grippers of linear driven gripper carts of the sheet transport system. The sheets are transported by the gripper carts into the processing stations and the gripper carts are halted once the sheet is located in the middle of the processing station. The sheet positioning occurs independently of the sheet format. After this positioning, the slanted sheet orienting and the perimeter register orienting is performed by incremental movements of the linear drives, which are situated at each outer end of a gripper cart. Once the sheet is register-oriented, it can be processed. The steps of sheet transport into the processing stations with sheet positioning, slanted sheet and perimeter register orienting, and sheet processing are repeated for each sheet in a particular processing station.

In the setup mode of the sheet punching and embossing machine, the method for operating the sheet punching and embossing machine is advantageously supplemented by two additional steps: a trial sheet is removed for inspection, i.e., a sheet processed by the machine is compared to its nominal processing. Depending on the difference between nominal processing and actual processing, correction values for the perimeter and the slanting register are entered by an interface into the machine control system in the particular processing stations.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a sheet processing machine according to a preferred embodiment of the present invention.

FIG. 2 illustrates a conceptual plan of the sheet punch including a transport system having a linear drive.

### DETAILED DESCRIPTION OF PREFERRED EMBODIMENTS

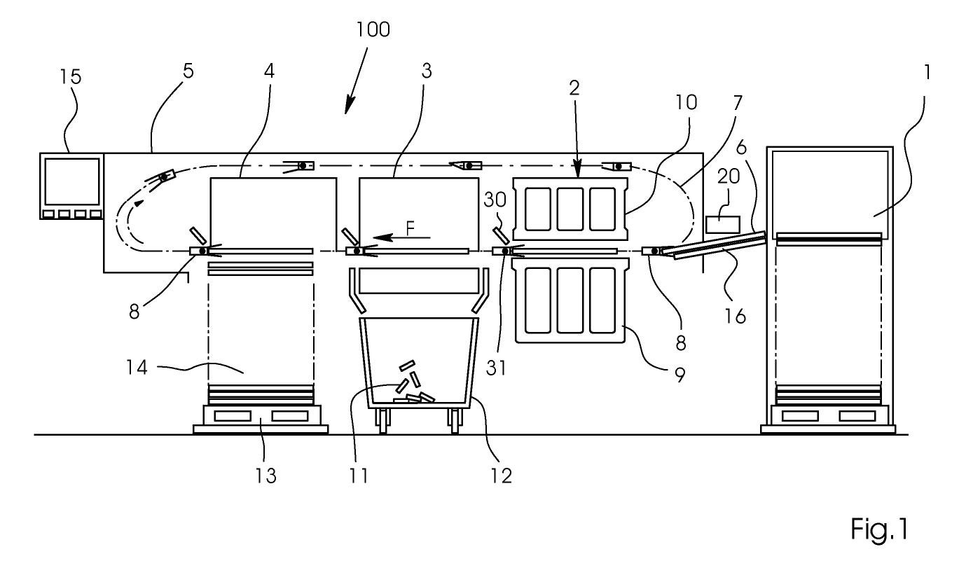

FIG. 1 shows the basic layout of a sheet punching and embossing machine 100 for the punching, detaching and delivery of sheets of paper, cardboard or the like. The punching and embossing machine 100 has a feeder device 1, a punching station 2, a detaching station 3 and a delivery unit 4, which are supported and surrounded by a common machine housing 5.

The sheets 6 are taken singly from a stack by a feeder unit 1 and a feed table 16, and fed and grabbed at their front edge by grippers fastened to gripper bridges of gripping carts 8 and intermittently pulled in the sheet delivery direction F through the various stations 2, 3, and 4 of the punching and embossing machine 100. On the gripper carts 8 there are signal generators 31, which can be configured, for example, as magnetic or light emitting elements.

In the area of the feed table 16 between feeder unit 1 and punching station 2 there is preferably provided a measuring system 20 for exact surveying of the position of the sheet 6.

The punching station 2 preferably includes a bottom table 9 and a top table 10. The bottom table 9 is fixedly mounted in the machine frame and provided with a counterplate for the punching blade. The top table 10 is mounted such that it can move back and forth vertically.

The gripping cart 8 transports the sheet 6 from the punching and embossing machine 2 to the following detachment station 3, which is outfitted with detachment dies. At the detaching station 3, the unneeded waste pieces from the sheet 6 are pushed downward by the detaching dies, so that the waste pieces 11 drop into a bin-like cart 12 underneath the station.

From the detaching station 3, the sheet is moved to the delivery unit 4, where the sheet is either merely stacked, or a separation of the individual copy units can occur at the same time. The delivery unit 4 can also include a pallet 13 on which the individual sheets are placed in the form of a stack 14, so that after reaching a certain stack height, the pallets with the stacked sheets 14 can be driven away from the area of the punching and embossing machine 100.

At the respective processing stations 2, 3, 4, there are sensors 30 which detect the exact position of the gripper cart 8 by receiving signals sent out by the signal generators 31 of the gripper cart 8. The values detected by the sensors 30 are transmitted for evaluation to the machine control system 15. The machine control system 15 has an interface for display and entry of machine parameters.

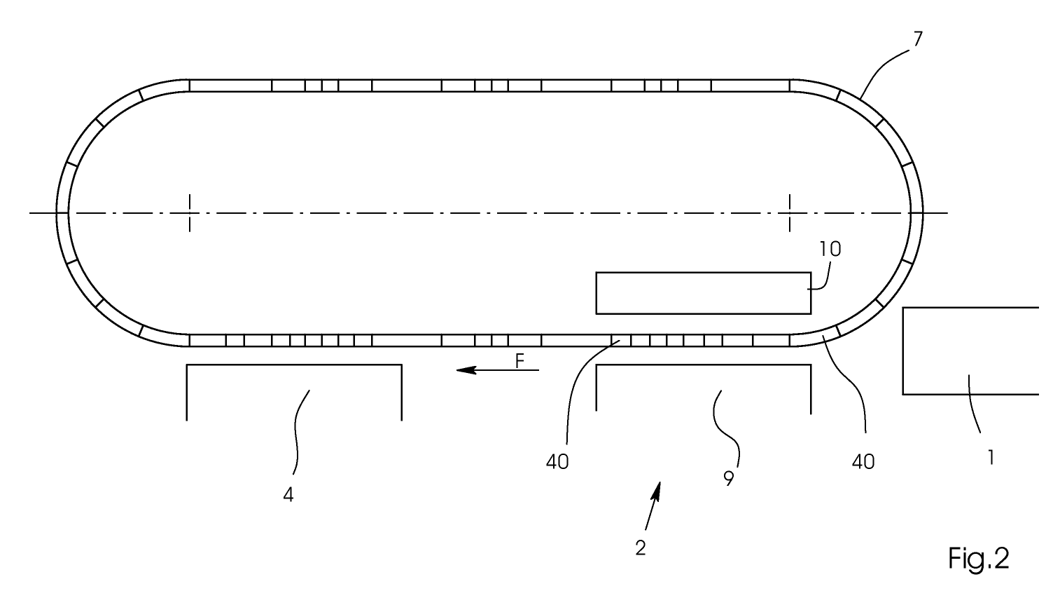

The stationary part of the sheet transport system 7 is depicted in FIG. 2. The sheet transport system 7 preferably includes two circulatory guide rails, oriented parallel or substantially parallel to each other, and including a plurality of stator segments 40. Along the guide rails of the sheet transport system 7, gripper carts 8 can be driven in the sheet transport direction F through the processing stations 2, 4. The gripper carts 8 have armatures (not shown in FIG. 2), which interact with the stationary stator segments 40 as linear motors.

In the region of the processing stations 2, 4, the guide rails are especially finely articulated thanks to a large number of stator segments 40. This ensures that a gripper cart 8 (not shown in FIG. 2) and the sheet 6 being transported by grippers at the gripping edge of the sheet can be halted register-true. Each stator segment 40 is coordinated with a frequency converter (not shown in FIG. 2) to build up a magnetic field in the stator segment 40, which is actuated by a central control system 15.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A sheet punching and embossing machine comprising:
a frame;
a sheet feeder unit;
at least one punching station;
at least one additional processing station;
a machine control system; and
a sheet transport system including circulating gripper carts having gripper bridges and grippers fixed on the gripper bridges by which the sheets can be grabbed and moved through the machine; wherein
the circulating gripper bridges of the gripper carts are driven at their outer ends by at least one linear drive each and the sheets at their sheet stopping positions in the at least one punching station and the at least one additional processing station are oriented in their perimeter direction and in their slanting position by the movement generated by the linear drives.

2. The sheet punching and embossing machine according to claim 1, further comprising an optical measuring system arranged to survey each sheet at least before a first processing station.

3. The sheet punching and embossing machine according to claim 2, wherein the measuring system is operatively connected to the machine control system and the sheet transport system such that data can be exchanged therebetween.

4. The sheet punching and embossing machine according to claim 1, wherein the sheet punching and embossing machine includes a position detecting mechanism arranged to determine a position of the gripper cart, the position detecting mechanism including sensors fixed to the frame and signal generators fixed to the respective gripper cart.

5. The sheet punching and embossing machine according to claim 1, the gripper carts are arranged to be moved both forward and backward by the linear drives.

6. A method for operating a sheet punching and embossing machine including a sheet feeder unit, at least one processing station and a sheet transport system, the method comprising the following steps:
a) removing a single sheet from a stack using the sheet feeder unit;
b) rough-orienting the single sheet at its front and side edge;
c) grabbing the single sheet with a preliminary gripper system;
d) surveying a printed image on the single sheet via a measuring system;
e) comparing the printed image surveyed to a nominal position;
f) calculating correction values for slanting sheet, side register and perimeter register;
g) side register orienting the single sheet via a feed system;
h) passing-off the single sheet to gripper carts of the sheet transport system;
i) transporting the single sheet into the at least one processing station and positioning the single sheet in the middle of the at least one processing station regardless of sheet format;
j) slanting sheet and perimeter register orienting the single sheet;
k) performing an operation of the at least one processing station;
l) repeating steps j, k and l for each sheet in the at least one processing station.

7. A method for operating a sheet punching and embossing machine according to claim 6, further comprising the steps of:
m) inspecting a trial sheet during a set up operation; and
n) correcting for perimeter and slanting register in each of a plurality of the processing stations based on the inspection performed in step m.
